(19) United States
(12) Patent Application Publication
(10) Pub. No.: US 2023/0365017 A1
(43) Pub. Date: Nov. 16, 2023

(54) ON-BOARD DIRECT-CURRENT FAST CHARGER SYSTEMS, METHODS, AND DEVICES FOR FUEL CELL VEHICLES

(71) Applicant: GM GLOBAL TECHNOLOGY OPERATIONS LLC, Detroit, MI (US)

(72) Inventor: Douglas Hildebrand Oi, Lyon Township, MI (US)

(73) Assignee: GM GLOBAL TECHNOLOGY OPERATIONS LLC, Detroit, MI (US)

(21) Appl. No.: 17/740,525

(22) Filed: May 10, 2022

(51) Int. Cl. B60L 53/54; B60L 53/16; B60L 53/18; B60L 53/22; B60L 53/57; B60L 53/66; B60L 53/30

(52) U.S. Cl. CPC B60L 53/54; B60L 53/16; B60L 53/18; B60L 53/22; B60L 53/305; B60L 53/57; B60L 53/66; B60L 2210/14

(57) ABSTRACT

Presented are direct-current fast charger (DCFC) systems for fuel cell vehicles, methods for making/using such systems, and electric-drive vehicles equipped with fuel cell systems (FCS) and on-board DCFC systems. An on-board DCFC system mounts to a host vehicle and includes an electrical connector that electrically couples the host vehicle’s FCS system to multiple distinct transferee vehicles. A high-voltage (HV) distribution unit contains an HV bus circuit that electrically connects to the host vehicle’s FCS system and electrified powertrain. A DC-to-DC converter is electrically connected to the HV bus circuit to thereby receive an output voltage from the FCS via the HV distribution unit. The DC-to-DC converter modulates the FCS voltage to a recharge voltage of a transferee vehicle. A contactor module is electrically connected to the DC-to-DC converter and electrical connector and selectively connects the DC-to-DC converter to the electrical connector to transfer the recharge voltage to the transferee vehicle.

### INTRODUCTION

The present disclosure relates generally to electrochemical fuel cell systems for converting hydrogen-rich fuels into electricity. More specifically, aspects of this disclosure relate to on-vehicle fuel cell systems for powering an electrified powertrain of a vehicle.

Current production motor vehicles, such as the modern-day automobile, are originally equipped with a powertrain that operates to propel the vehicle and power the vehicle’s onboard electronics. In automotive applications, for example, the vehicle powertrain is generally typified by a prime mover that delivers driving torque through an automatic or manually shifted power transmission to the vehicle’s final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

Hybrid-electric and full-electric powertrains take on various architectures, some of which utilize a fuel cell system (FCS) to generate the requisite electricity for powering the vehicle’s electric traction motor(s). A fuel cell is an electrochemical device generally composed of an anode electrode that receives hydrogen (H₂), a cathode electrode that receives oxygen (O₂), and an electrolyte barrier interposed between the anode and cathode electrodes. An electrochemical reaction is induced to oxidize hydrogen molecules at the anode side of the FCS — hydrogen gas is catalytically split in an oxidation half-cell reaction — to generate free electrons (-) and free protons (H+). The free hydrogen protons pass through the electrolyte to the cathode, where these protons react with oxygen and electrons in the cathode to form various stack by-products. Free electrons from the anode, however, cannot pass through the electrolyte; these electrons are redirected to a load, such as a vehicle’s traction motors and accessories, before being sent to the cathode.

Fuel cell designs commonly employed in automotive applications utilize a solid polymer electrolyte membrane (PEM) — also referred to as a “proton exchange membrane” — to provide ion transport between the anode and cathode. Proton exchange membrane fuel cells (PEMFC) generally employ a solid polymer electrolyte (SPE) proton-conducting membrane, such as a perfluorosulfonic acid membrane, to separate product gases and provide electrical insulation of electrodes, in addition to conduction of protons. The anode and cathode are generally composed of finely dispersed catalytic particles (e.g., platinum) that are supported on carbon particles and mixed with an ionomer. This catalytic mixture is deposited on the sides of the membrane to form the anode and cathode layers. The combination of the anode catalytic layer, cathode catalytic layer, and electrolyte membrane define a membrane electrode assembly (MEA) in which the anode catalyst and cathode catalyst cover opposite faces of the ion conductive solid polymer membrane. To yield the requisite electricity for powering an automobile, multiple fuel cells are assembled into a fuel cell stack to achieve a higher output voltage and allow for stronger current draw. A typical fuel cell stack, for example, may have in excess of two hundred stacked fuel cells.

As hybrid and electric vehicles become more prevalent, infrastructure is being developed and deployed to make day-to-day use of such vehicles feasible and convenient. Electric vehicle supply equipment (EVSE) for recharging such electric-drive vehicles comes in many forms, including residential electric vehicle charging stations (EVCS) that are purchased and operated by a vehicle owner (e.g., installed in the owner’s garage). Other EVSE examples include publicly accessible EVCS made available by public utilities or private retailers (e.g., at municipal charging facilities or commercial charging stations), and sophisticated high-voltage, high-current charging stations used by manufacturers, dealers, and service stations. Plug-in hybrid and electric vehicles, for instance, can be recharged by physically connecting a charging cable of the EVCS to a complementary charging port of the vehicle. By comparison, wireless charging systems utilize electromagnetic field (EMF) induction or other wireless power transfer (WPT) technology to provide vehicle charging capabilities without the need for charging cables and cable ports. It is axiomatic that large-scale vehicle electrification in turn necessitates a concomitant buildout of readily accessible charging infrastructure that can support daily vehicle use in both urban and rural scenarios, for both short-distance and long-distance vehicle ranges.

### SUMMARY

Presented herein are direct-current fast charger (DCFC) systems for fuel cell vehicles, methods for manufacturing and methods for operating such systems, and FCS motor vehicles equipped with on-board DC fast chargers. By way of example, there are disclosed commercial-class fuel cell electric vehicles (FCEV) that carry large hydrogen containers for stowing a significant amount of hydrogen fuel that may be used for both vehicle propulsion and charging other electric-drive vehicles. An on-board DCFC module is permanently or removably mounted to a host vehicle and operational to identify the charging needs and constraints of a transferee vehicle and to regulate charging voltage during power transfer to that vehicle. The DCFC module may utilize an SAE DC Level 2 charging cable and J-plug to enable connection and communication with the transferee vehicle. Contained within the DCFC module is a DC-to-DC converter located upstream from a contactor module, which is interposed between the charging cable and converter. The DC-to-DC converter regulates voltage received from FCS, which is stepped up or down to match the desired charge voltage of the transferee vehicle. The contactor module governs the electrical coupling between the host and transferee vehicles while monitoring charge voltage and communicating with the transferee vehicle’s battery charge module (BCM). A high-voltage (HV) distribution center contains an HV circuit, bus, or other apt connection to transfer electrical power from the host vehicle’s FCS to its electrified powertrain and to the DCFC module for charging transferee vehicles. An auxiliary power module (APM) contains step-down electronics and a low-voltage (LV) circuit, bus, or other suitable connection to power the individual hardware modules within the DCFC module.

Attendant benefits for at least some of the disclosed concepts include DCFC systems for FCEVs that abate the need for large-volume, grid-based EVCS that are permanently mounted to private/public infrastructure. Deployable and sharable on-board DCFC modules eliminate the associated cost, maintenance, installation time, and dedicated space for fixed EVCS. Other attendant benefits may include the use of FCSs to enable vehicle-to-vehicle charging and, thus, eliminating reliance on public electric grids that may be expensive (e.g., power factor and peak-demand penalties) or unavailable (e.g., power outages). To electric-drive vehicle owners, these mobile DCFC systems offer increased driving ranges with reduced range anxiety by enabling wide-spread charger distribution.

Aspects of this disclosure are directed to mobile vehicle-to-vehicle charging systems for motor vehicles equipped with a fuel cell system (i.e., FCS vehicles). In an example, there is presented an on-board direct-current fast charger system for mounting to a host vehicle, which is equipped with an electrified powertrain and a fuel cell system operable to output an FCS voltage sufficient to power the vehicle’s electrified powertrain. This representative on-board DCFC system includes an electrical connector that physically and electrically couples to any of multiple distinct transferee vehicles requesting/receiving a recharge. A high-voltage distribution unit contains an HVDC bus circuit that electrically connects to the host vehicle’s FCS and electrified powertrain. A DC-to-DC boost converter is electrically connected to the HV bus circuit to thereby receive the host FCS’s output voltage from the HV distribution unit; the DC-to-DC converter modulates the FCS voltage to a recharge voltage requested by the transferee vehicle. A contactor module is electrically connected to both the DC-to-DC converter and the electrical connector and operable to selectively connect the DC-to-DC converter to the electrical connector in order to transfer the recharge voltage to the transferee vehicle.

Additional aspects of this disclosure are directed to FCS vehicles with original-equipment or aftermarket vehicle-to-vehicle charging systems. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, an electric-drive vehicle includes a vehicle body with a passenger compartment, multiple road wheels mounted to the vehicle body (e.g., via corner modules coupled to a unibody or body-on-frame chassis), and other standard original equipment. An electrified powertrain contains one or more vehicle-mounted traction motors that operate alone (e.g., for FEV powertrains) or in conjunction with an internal combustion engine assembly (e.g., for HEV powertrains) to selectively drive one or more of the road wheels and thereby propel the vehicle. A resident FCS, which is mounted to the vehicle, oxidizes a hydrogen-based fuel to thereby generate an FCS voltage to power the electrified powertrain. An HV distribution unit contains an HVDC bus circuit that is interposed between and electrically connects the vehicle’s FCS and electrified powertrain.

Continuing with the discussion of the preceding example, the vehicle is equipped with an on-board DCFC system for charging any of an assortment of transferee vehicles. The DCFC system is generally composed of an electrical connector that electrically couples to a transferee vehicle, and a DC-to-DC converter that electrically connects to the HV bus circuit and receive therefrom the FCS’s output voltage passed through the HV distribution unit. The DC-to-DC converter modulates the FCS voltage to a recharge voltage requested by the transferee vehicle. A contactor module is interposed between and electrically connected to the DC-to-DC converter and the electrical connector. The contactor module selectively connects the DC-to-DC converter to the electrical connector to thereby transfer the modulated recharge voltage to the transferee vehicle.

Aspects of this disclosure are also directed to DCFC control logic, memory-stored computer readable media (CRM), and manufacturing processes for making/using vehicle-to-vehicle charging systems of FCS vehicles. In an example, a method is presented for assembling an on-board direct-current fast charger system to a host vehicle. This representative method includes, in any order and in any combination with any of the above and below disclosed options and features: fabricating, assembling, accepting, or retrieving (collectively “receiving”) an electrical connector configured to electrically couple to a transferee vehicle distinct from the host vehicle; electrically connecting an HV bus circuit of an HV distribution unit to the host vehicle’s FCS and electrified powertrain; electrically connecting a DC-to-DC converter to the HV bus circuit, the DC-to-DC converter configured to receive the FCS voltage from the HV distribution unit and modulate the FCS voltage to a recharge voltage of the transferee vehicle; and electrically connecting a contactor module to the DC-to-DC converter and the electrical connector, the contactor module configured to selectively connect the DC-to-DC converter to the electrical connector to thereby transfer the recharge voltage to the transferee vehicle.

For any of the disclosed systems, methods, and vehicles, the DC-to-DC converter may include an electrical boost inductor that is electrically connected to the HV bus circuit, and an HVDC bulk capacitor that is electrically connected to the boost inductor and the contactor module. In this instance, the boost inductor may include multiple inductor resistors that are electrically connected in parallel with each other and electrically connected across the positive and negative ends of the HVDC bulk capacitor. As yet another option, the DC-to-DC converter may also include a boost power module that is electrically connected to and interposed between the boost inductor and the HVDC capacitor. This boost power module includes multiple gate terminal switches and multiple diodes; each diode may be electrically connected in series to a respective one of the inductor resistors and a respective one of the gate terminal switches.

For any of the disclosed systems, methods, and vehicles, the contactor module may include a contactor box with an electrically-controlled positive contactor that is electrically connected to a positive bus line of the HV bus circuit, and an electrically-controlled negative contactor that is electrically connected to a negative bus line. The contactor module may also include a voltage and isolation resistance sensing (ISO) meter that is electrically connected to the contactor box and operable to monitor voltage output of the contactor module and isolation resistance of the system. As yet another option, an electrical fuse may be placed downstream from both the positive and negative contactors; this fuse selectively interrupts electrical flow across the positive and negative bus lines at a predefined maximum voltage and/or current.

For any of the disclosed systems, methods, and vehicles, the HV distribution unit may electrically connect in between the vehicle FCS and the DC-to-DC converter, the DC-to-DC converter may electrically connect in between the HV distribution unit and the contactor module, and the contactor module may electrically connect in between the DC-to-DC converter and the electrical connector. In another example, the DC-to-DC converter and the contactor module may be electrically connected to an auxiliary power module of the host vehicle to receive therefrom an APM voltage to power operation of the DCFC system’s converter and contactor module. A vehicle controller area network (CAN) communication module may be connected to the DC-to-DC converter and contactor module. The vehicle CAN module communicates with an on-board battery charge module (OBCM) of the transferee vehicle to receive therefrom charging data, such as the requested recharge voltage, charging constraints, communication protocols, etc.

For any of the disclosed systems, methods, and vehicles, the electrical connector may include a power cable that is coupled at one (host) end thereof to the connector module and at another (transfer) end thereof to a power plug. The power plug may contain an assortment of connector pins, including complementary HV direct current (DC+) pins, a proximity pin, a control pilot pin, etc. In this instance, the vehicle CAN module may be connected to the power plug and communicates with the transferee vehicle’s OBCM via the control pilot pin. In some examples, the on-board DCFC system is a modular unit with a DCFC module housing that stores the DC-to-DC converter, contactor module, and electrical connector. The DCFC module housing is structurally configured to detachably mount to a vehicle body of the vehicle. The HV distribution unit may include an HV module housing that contains the HVDC bus, a first set of switches selectively electrically connecting positive and negative bus lines of the HV bus circuit to the vehicle RESS, and a second set of switches selectively electrically connecting the positive and negative bus lines of the HV bus circuit to the DC-to-DC converter.

The above Summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with an electrified powertrain, a rechargeable energy storage system (RESS), a fuel cell system (FCS), and a network of in-vehicle controllers, sensing devices, and communication devices for providing mobile vehicle-to-vehicle charging in accordance with aspects of the disclosed concepts.

FIG. 2 is a schematic illustration of the representative motor vehicle of FIG. 1 with an on-board direct-current fast charger system and an assortment of optional hardware for the vehicle’s FCS, RESS, and powertrain.

FIG. 3 is a diagrammatic illustration of a representative DC-to-DC boost converter (DC-DC CON) module in accord with aspects of the disclosed concepts.

FIG. 4 is a diagrammatic illustration of a representative contactor, voltage, and isolation sensing (CVIS) module in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, subcombinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

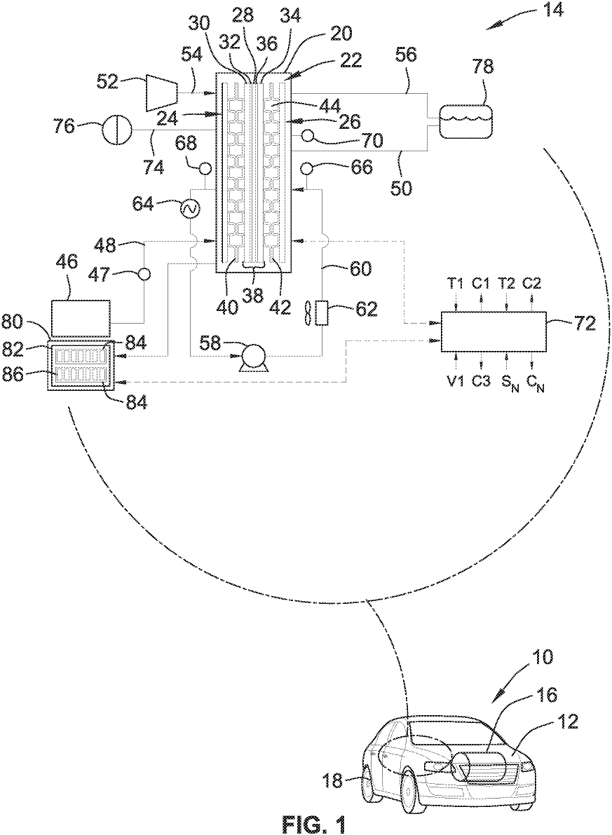

Referring now to the drawings, wherein like reference numbers refer to like features throughout the several views, there is shown in FIG. 1 a representative automobile, which is designated generally at 10 and portrayed herein for purposes of discussion as a sedan-style, fuel cell electric vehicle (FCEV). The illustrated automobile 10 — also referred to herein as “motor vehicle” or “vehicle” for short — is merely an exemplary application with which novel aspects of this disclosure may be practiced. In the same vein, incorporation of the present concepts into a full-electric powertrain should be appreciated as a non-limiting implementation of disclosed features. As such, it will be understood that aspects and features of this disclosure may be applied to other powertrain architectures, utilized for a variety of different fuel cell system configurations, and incorporated into any logically relevant type of vehicle. Moreover, only select components of the motor vehicles, DCFCs, and fuel cell systems are shown and described in additional detail herein. Nevertheless, the vehicles and systems discussed below may include numerous additional and alternative features, and other available peripheral components, for carrying out the various methods and functions of this disclosure.

Packaged within the vehicle body 12 of automobile 10 is a representative fuel cell system 14 for powering a prime mover, such as electric motor generator unit (MGU) 16, that is operable for driving a combination of the vehicle’s road wheels 18. Proton exchange membrane fuel cell system 14 of FIG. 1 is equipped with one or more fuel cell stacks 20, each of which is composed of multiple fuel cells 22 of the PEM type that are stacked and connected in electrical series or parallel with one another. In the illustrated architecture, each fuel cell 22 is a multi-layer construction with an anode side 24 and a cathode side 26 that are separated by a proton-conductive perfluorosulfonic acid membrane 28. An anode diffusion media layer 30 is provided on the anode side 24 of the PEMFC 22, with an anode catalyst layer 32 interposed between and operatively connecting the membrane 28 and corresponding diffusion media layer 30. Juxtaposed in opposing spaced relation to the anode layers 30 and 32 is a cathode diffusion media layer 34, which is provided on the cathode side 26 of the PEMFC 22. A cathode catalyst layer 36 is interposed between and operatively connects the membrane 28 and corresponding diffusion media layer 34. The two catalyst layers 32 and 36 cooperate with the membrane 28 to define, in whole or in part, a membrane electrode assembly (MEA) 38.

The diffusion media layers 30 and 34 are porous constructions that provide for fluid inlet transport to and fluid exhaust transport from the MEA 38. An anode flow field plate (or “first plate”) 40 is provided on the anode side 24 in abutting relation to the anode diffusion media layer 30. In the same vein, a cathode flow field plate (or “second plate”) 42 is provided on the cathode side 26 in abutting relation to the cathode diffusion media layer 34. Coolant flow channels 44 traverse each of the plates 40 and 42 to allow cooling fluid to flow through the fuel cell 22. Fluid inlet ports and headers direct a hydrogen-rich fuel and an oxidizing agent to respective passages in the anode and cathode flow field plates 40, 42. A central active region of the anode’s plate 40 that faces the proton-conductive membrane 28 may be fabricated with an anode flow field composed of serpentine flow channels for distributing hydrogen over an opposing face of the membrane 28. The MEA 38 and plates 40, 42 may be stacked together between stainless steel clamping plates and monopolar end plates (not shown). These clamping plates may be electrically insulated from the end plates by a gasket or dielectric coating. The fuel cell system 14 may also employ anode recirculation where an anode recirculation gas is fed from an exhaust manifold or headers through an anode recirculation line for recycling hydrogen back to the anode side 24 input so as to conserve hydrogen gas in the stack 20.

Hydrogen (H₂) inlet flow — be it gaseous, concentrated, entrained, or otherwise — is transmitted from a hydrogen source, such as fuel storage tank 46, to the anode side 24 of the fuel cell stack 20 via a fluid injector 47 coupled to a (first) fluid intake conduit or hose 48. Anode exhaust exits the stack 20 via a (first) fluid exhaust conduit or hose 50. Although shown on the inlet side of the stack, a compressor or pump 52 provides a cathode inlet flow, such as ambient air and/or concentrated gaseous oxygen (O₂), via a (second) fluid intake line or manifold 54 to the cathode side 26 of the stack 20. Cathode exhaust is output from the stack 20 via a (second) fluid exhaust conduit or manifold 56. Flow control valves, flow restrictions, filters, and other available devices for regulating fluid flow can be implemented by the PEMFC system 14 of FIG. 1. Electricity generated by the fuel cell stack(s) 20 and output by the fuel cell system 14 may be transmitted for storage to an in-vehicle traction battery pack 82 within a rechargeable energy storage system (RESS) 80.

Fuel cell system 14 of FIG. 1 may also include a thermal sub-system operable for controlling the temperature of the fuel cell stack 20 during preconditioning, break-in, and post-conditioning. According to the illustrated example, a cooling fluid pump 58 pumps a cooling fluid through a coolant loop 60 to the fuel cell stack 20 and into the coolant channels 44 in each cell 22. A radiator 62 and an optional heater 64 fluidly coupled in the coolant loop 60 are used to maintain the stack 20 at a desired operating temperature. This fuel cell conditioning system may be equipped with various sensing devices for monitoring system operation and progress of fuel cell break-in. For instance, a (first) temperature sensor 66 monitors a temperature value of the coolant at a coolant inlet to the fuel cell stack 20, and a (second) temperature sensor 68 measures a temperature value of the coolant at a coolant outlet of the stack 20. An electrical connector or cable 74 connects the fuel cell stack 20 to an electric power load 76, which may be employed to draw a current from each cell 22 in the stack 20. A voltage/current sensor 70 is operable to measure, monitor, or otherwise detect fuel cell voltage and/or current across the fuel cells 22 in the stack 20.

Programmable electronic control unit (ECU) 72 helps to control operation of the fuel cell system 14. As an example, ECU 72 receives one or more temperature signals T1 from one or more of the temperature sensors 66, 68 that indicate the temperature of the fuel cell stack 20; ECU 72 may be programmed to responsively issue one or more command signals C1 to modulate operation of the stack 20. ECU 72 of FIG. 1 also receives one or more voltage signals V1 from the voltage sensor/current 70; ECU 72 may be programmed to responsively issue one or more command signals C2 to modulate operation of a hydrogen source (e.g., fuel storage tank 46) and/or compressor/pump 52 to thereby regulate the electrical output of the stack 20. ECU 72 of FIG. 1 is also shown receiving one or more coolant temperature signals T2 from sensor 66 and/or 68; ECU 72 may be programmed to responsively issue one or more command signals C3 to modulate operation of the fuel cell’s thermal system. Additional sensor signals S_{N} may be received by, and additional control commands C_{N} may be issued from the ECU 72, e.g., to control any other sub-system or component illustrated and/or described herein. The ECU 72 may emit a command signal to transmit evolved hydrogen and liquid H₂O from the cathode side 26 through fluid exhaust conduit 56 to a water separator 78 (FIG. 1) where hydrogen and water from the cathode are combined with depleted hydrogen exhausted from the anode through fluid exhaust conduit/hose 50.

With continuing reference to FIG. 1, the traction battery pack 82 contains an array or rechargeable lithium-class (secondary) battery modules 84. Aspects of the disclosed concepts may be similarly applicable to other electric storage unit architectures, including those employing nickel metal hydride (NiMH) batteries, lead acid batteries, lithium metal batteries, or other applicable type of rechargeable electric vehicle battery (EVB). Each battery module 84 may include a series of electrochemical battery cells, such as pouch-type lithium ion (Li-ion) or Li-ion polymer battery cells 86. An individual battery module 84, for example, may be typified by a grouping of 10-45 Li-ion battery cells that are stacked in side-by-side facing relation with one another and connected in parallel or series for storing and supplying electrical energy. While described as silicon-based, Li-ion “pouch cell” batteries, the cells 86 may be adapted to other constructions, including cylindrical and prismatic constructions.

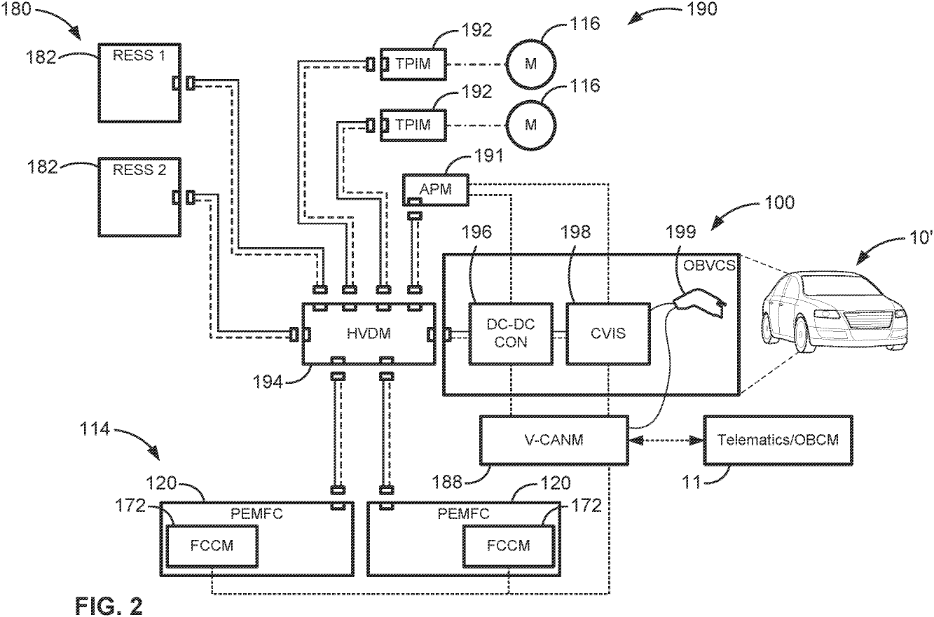

Turning next to FIG. 2, there is shown another schematic illustration of the representative FCS vehicle 10 of FIG. 1 in which the FCS vehicle 10′ of FIG. 2 is equipped with an on-board direct-current fast charger (DCFC) system 100 for provisioning on-demand and mobile vehicle-to-vehicle charging services. Although differing in appearance, it is envisioned that any of the features and options described above with reference to the vehicle 10 of FIG. 1 may be incorporated, singly or in any combination, into the vehicle 10′ of FIG. 2, and vice versa. As a point of similarity, the vehicle 10′ of FIG. 2 is equipped with an electrochemical fuel cell system 114 composed of one or more stacks 120 of hydrogen-oxidizing PEM fuel cells. Integrated into each fuel cell stack 120 is an electronic fuel cell control module (FCCM) 172 that exchanges data signals with a vehicle CAN propulsion master (V-CANM) module 188 to govern operation of the stack 120, e.g., in a manner similar to that described above with respect to ECU 72 of FIG. 1. It should be appreciated that the fuel cell systems illustrated in FIGS. 1 and 2 may take on alternative architectures and may employ any suitable fuel cell technology, including solid acid, phosphoric, and alkaline-type FCS.

Vehicle 10 of FIG. 2, like vehicle 10 of FIG. 1, is propelled by an electrified powertrain 190 with one or more multi-phase electric traction motors (M) 116 that deliver tractive torque to the vehicle’s drive wheels (i.e., road wheels 18 of FIG. 1). A pair of traction power inverter modules (TPIM) 192 converts the DC voltage output by the PEM fuel cell system 114 to a three-phase AC current for driving the traction motors 116. Each TPIM 192 includes complementary three-phase power electronics devices, insulated gate bipolar transistors, and motor control module (MCM) hardware that receives torque command requests for outputting motor drive or regenerative braking functionality. A rechargeable energy storage system (RESS) 180 contains one or more traction battery packs 82 that stores electrical power generated by the fuel cell system 114. While not per se limited, the vehicle 10′ may be particularly suited for a front-and-rear independent drive (FRID) powertrain with dual independent electric drive units (EDU) and a dual-pack RESS that enables on-demand all-wheel drive (AWD) capabilities.

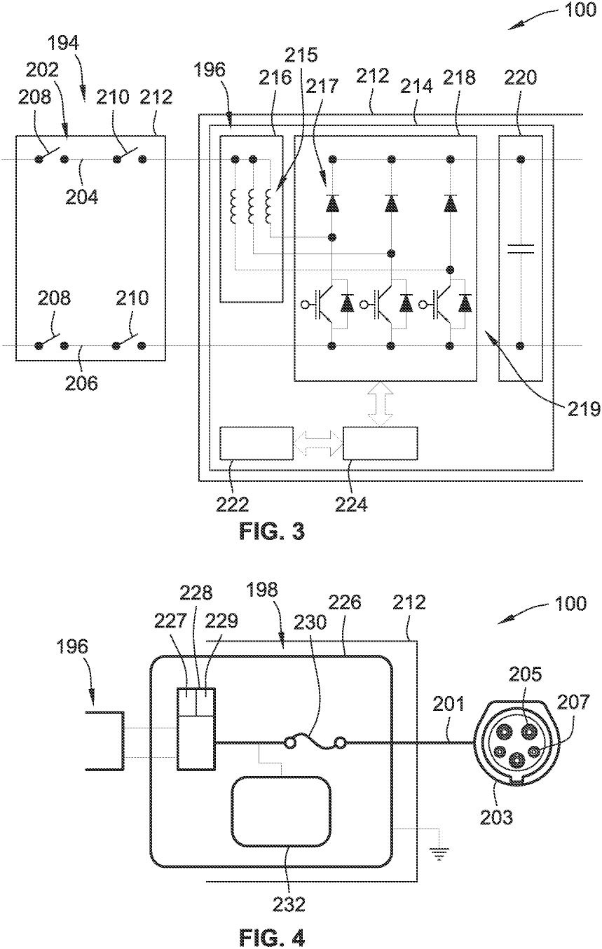

A high-voltage direct current distribution unit (HVDU) 194 acts as central interface for electrically interconnecting and enabling proper power sharing between the fuel cell system 114, the vehicle RESS 180, the electrified powertrain 190, and the on-board DCFC system 100. As shown, the HVDU 194 is electrically interposed between and may act as the sole intermediary electrical coupling for: (1) the fuel cell system 114 and RESS 180; (2) the fuel cell system 114 and powertrain 190; (3) the fuel cell system 114 and DCFC system 100; (4) the RESS 180 and powertrain 190; and (4) the RESS 180 and DCFC system 100. For modular architectures, an example of which is shown in FIG. 3, the HVDU 194 includes a protective and electrically insulated HVDM module housing 200 that contains an HVDC bus circuit 202. In practice, the FCS 114 may provide at least about 200 volts (V) of power on positive and negative bus lines 204 and 206, respectively, during a full-load demand driving state, and may provide at least about 300 V across the bus lines 204, 206 during a vehicle idle state. To boost the voltage output of the vehicle FCS 114, a respective DC-to-DC boost converter (DC CON) 193 may be electrically interposed between each fuel cell stack 120 and the HVDU 194. As a representative point of demarcation, a “low-voltage” circuit in automotive applications may have a voltage rating of about 60 V or less (e.g., for air-conditioning compressors, passenger cabin electronics, and other auxiliary devices), whereas a “high-voltage” circuit may have a voltage rating in excess of about 200 V (e.g., for powering traction motors and recharging traction battery packs). While shown with a single HV distribution unit, the host vehicle 10′ may integrate an HV distribution system with multiple HV distribution units.

As best seen in FIG. 3, the HVDU module 194 may include an optional first set of switches 208 that selectively electrically connects the positive and negative bus lines 204, 206 of the HVDC bus circuit 202 to the vehicle’s FCS 114, RESS 180, and/or powertrain 190. A second set of switches 210 selectively electrically connects the positive and negative bus lines 204, 206 of the HVDC bus circuit 202 to a DC-to-DC converter 196 (DC-DC CON) of the DCFC system 100. Although not shown, distinct switch sets may be integrated into the HVDC bus circuit 202 to selectively connect/isolate the HVDU 194 to/from the traction battery packs 182 and the electric traction motors 116. Other optional electrical components may include a stack blocking diode (not shown) positioned on the positive bus line 204 to prevent electrical current from flowing back into the fuel cell stacks 120. An optional pack blocking diode (not shown) may be positioned on the positive bus line 204 to prevent electrical current from flowing into the traction battery packs 182 when fully charged. An optional bypass switch (not shown) may circumvent the pack blocking diode so that the battery packs 182 may be recharged by the fuel cell system 114 or the motors 116 during regenerative braking.

Mobile vehicle-to-vehicle charging capabilities are enabled by an on-board direct-current fast charger system 100 that allows the vehicle 10′ of FIG. 2 to electrically couple its FCS 114 and RESS 180 to any of an assortment of transferee vehicles 11, including third-party plug-in electric vehicles (PEV) in need of a recharge. According to the illustrated architecture, the DCFC system 100 electrically connects to the host vehicle’s fuel cell stacks 120 and battery packs 182 by way of the HVDU module 194, which is electrically positioned in between the vehicle FCS 114 and the DC-to-DC converter 196. In this regard, the DC-to-DC converter 196 is electrically connected in between the HVDU module 194 and a contactor, voltage, and isolation sensing (CVIS) module 198 (also referred to herein as “contactor module”), whereas the CVIS module 198 is electrically connected in between the DC-to-DC converter 196 and an electrical connector 199. This electrical connector 199 may be manually operated by a user of the host vehicle 10 or transferee vehicle 11 to physically and electrically mate the transferor vehicle with the transferee vehicle to thereby exchange electrical power.

For modular architectures, the DCFC system 100 may be assembled into a protective and electrically insulated DCFC module housing 212 (FIGS. 3 and 4) that stores the DC-to-DC converter 196, the contactor module 198, and the electrical connector 199. This DCFC module housing 212 may be permanently mounted to the host vehicle 10 (e.g., via welding, riveting, etc.) or, alternatively, may detachably mount to the host vehicle 10 (e.g., via latches, straps, threaded fasteners, etc.). Both the DC-to-DC converter 196 and contactor module 198 are communicatively connected to an auxiliary power module (APM) 191 of the host vehicle 10′. The DC-to-DC converter 196 and contactor module 198 receive low-voltage electrical power from the APM 191 to operate the respective constituent components within the DC-DC CON and CVIS. A resident vehicle CAN module 188 communicates with the DC-to-DC converter 196 and contactor module 198, as well as an on-board battery charge module (OBCM) or telematics unit of the transferee vehicle 11, to coordinate recharging of the transferee vehicle 11. It should be appreciated that the DCFC system 100 may incorporate additional and alternative power electronics devices, electrical circuitry/components, user interfaces and input/output devices, charge cord/connectors, etc., without departing from the intended scope of this disclosure.

With reference to both FIGS. 2 and 3, the DC-to-DC converter 196 electrically connects the CVIS module 198 and electrical connector 199 to the HV bus circuit 202 of the HVDU module 194. In so doing, the DC-to-DC converter 196 of the vehicle’s on-board DCFC system 100 receives an output voltage from the FCS 114 — through the DC CONs 193 and HVDU module 194 — and steps up or steps down (i.e., modulates) this FCS voltage to a recharge voltage specific to/requested by the transferee vehicle 11. FCS power output may also be modulated to a desired charging rate/current. Put another way, DC-DC CON 196 regulates voltage received from the fuel cell stacks 120 to match the charge voltage of the vehicle being charged.

A modular converter construction may be assembled with a protective and electrically insulated DC-DC CON module housing 214 that contains a boost inductor 216, a boost power module 218, and an HVDC bulk capacitor 220. According to the illustrated example, the boost inductor 216 is electrically connected to the HV bus circuit 202 of the HVDU module 194, whereas the HVDC bulk capacitor 220 is electrically connected to the CVIS module 198 downstream from the boost inductor 216 and power module 218. The boost power module 218 is electrically connected to and interposed between the boost inductor 216 and capacitor 220. The DC-to-DC boost inductor 216 of FIG. 3 is generally composed of three inductor resistors 215 that are electrically connected in parallel with each other, electrically connected across one of the bus lines 204 to the HVDU module 194, and electrically connected across the boost power module 218 to the HVDC bulk capacitor 220. The boost power module 218 of FIG. 3 contains three mutually parallel gate terminal switches (collectively designated at 217) and three mutually parallel electrical diodes (collectively designated at 219). Each diode 219 is electrically connected in series to a respective inductor resistor 215 and a respective gate terminal switch 217. A signal module 222 functions as a signal electrical interface for processing control signals, and a gate module 224 functions as a gate drive electrical interface.

Operatively connecting and disconnecting the host vehicle’s fuel cell system 114 to and from the in-vehicle battery charging hardware of the transferee vehicle 11 is a contactor module 198 that works with the V-CANM 188 during charging to communicate with the transferee vehicle 11 and perform necessary measurements to facilitate charging. The CVIS module 198 of FIG. 4, for example, is electrically connected to and interposed between the DC-to-DC converter 196 and the DCFC electrical connector 199. During a vehicle-to-vehicle charging operation, the CVIS module 198 selectively connects the DC-to-DC converter and, thus, the fuel cell stacks 120 to the electrical connector 199, which in turn connects the vehicle FCS 114 to the transferee vehicle 11 for transferring thereto a modulated recharge voltage. The DC-DC CON 196 of FIG. 3 and the CVIS 198 of FIG. 4 are representative in nature and, thus, may take on alternative configurations.

For modular configurations, the CVIS module 198 includes a protective and electrically insulated CVIS module housing 226 that contains therein a contactor box 228, an electrical fuse 230, and a voltage and isolation resistance sensing (ISO) meter 232. To make and break the aforementioned electrical connections, the contactor box 228 contains an electrically-controlled positive contactor 227 that selectively electrically connects the CVIS module 198 to the positive bus line 204 of the HV bus circuit 202 via DC-DC CON 196, and an electrically-controlled negative contactor 229 that selectively electrically connects the CVIS module 198 to the negative bus line 206 of the HV bus circuit 202. Voltage, current, temperature, and other desired charging parameters may be measured by the ISO meter 232, which is electrically connected in between the contactor box 228 and fuse 230. The electrical fuse 230 is located downstream from the positive and negative contactors 227, 229 and functions to selectively interrupt electrical flow across the positive and negative bus lines 204, 206 to the electrical connector 199 when the output voltage of the DCFC system 100 meets or exceeds a system-calibrated maximum voltage.

On-board DCFC 100 of FIG. 2 offers wired vehicle-to-vehicle charging via a “plug-in” electrical connector 199, which may be one of a number of different commercially available or hereafter developed electrical connector types. By way of non-limiting example, electrical connector 199 may be a Society of Automotive Engineers (SAE) J1772 (Type 1) or J1772-2009 (Type 2) or International Electrotechnical Commission (IEC) 62196-2 and/or 62196-3 compatible electrical connector with direct current modes operating at about 50 to 1000 volts (V) and about 100 to 400 or more amperes (A) peak current for plug-in charging. The electrical connector 199 may generally comprise an HV electrical power cable 201 that is electrically coupled at one (host) end thereof to the contactor module 198 and at an opposing (transfer) end thereof to a DCFC power plug 203 (e.g., a CCS type 1 or type 2 power plug). The DCFC power connector plug 203 is equipped with an assortment of connector pins, including complementary HV direct current (DC+) pins 205, a proximity pin, single-phase alternating current (AC) line and neutral pins, protective earthing pin, and a control pilot pin 207. The vehicle CAN module 188 is wired or wirelessly connected to the power plug 203 and, through this piggyback connection, communicates with the transferee vehicle’s OBCM/telematics unit via mating engagement of the control pilot pin 207.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An on-board direct-current fast charger (DCFC) system for mounting to a vehicle, the vehicle including an electrified powertrain and a vehicle fuel cell system (FCS) configured to output an FCS voltage to power the electrified powertrain, the on-board DCFC system comprising:
an electrical connector configured to mount to the vehicle and to electrically couple the vehicle to a transferee vehicle;
a high-voltage (HV) distribution unit configured to mount to the vehicle and including an HV bus circuit configured to electrically connect to the vehicle FCS and the electrified powertrain;
a DC-to-DC converter electrically connected to the HV bus circuit and configured to receive the FCS voltage from the HV distribution unit and modulate the FCS voltage to a recharge voltage of the transferee vehicle; and
a contactor module electrically connected to the DC-to-DC converter and the electrical connector and configured to selectively connect the DC-to-DC converter to the electrical connector to thereby transfer the recharge voltage to the transferee vehicle.

2. The on-board DCFC system of claim 1, wherein the DC-to-DC converter includes a boost inductor electrically connected to the HV bus circuit and a high-voltage direct current (HVDC) bulk capacitor electrically connected to the contactor module.

3. The on-board DCFC system of claim 2, wherein the boost inductor includes a plurality of inductor resistors electrically connected in parallel with each other and electrically connected to the HVDC bulk capacitor.

4. The on-board DCFC system of claim 3, wherein the DC-to-DC converter further includes a boost power module electrically connected to and interposed between the boost inductor and the HVDC capacitor, the boost power module including multiple gate terminal switches and multiple diodes each electrically connected in series to a respective one of the inductor resistors and a respective one of the gate terminal switches.

5. The on-board DCFC system of claim 1, wherein the contactor module includes a contactor box with electrically-controlled positive and negative contactors electrically connected to positive and negative bus lines, respectively, of the HV bus circuit.

6. The on-board DCFC system of claim 5, wherein the contactor module further includes a voltage and isolation resistance sensing meter electrically connected to the contactor box and configured to monitor a system resistance and/or a voltage output of the contactor module.

7. The on-board DCFC system of claim 6, wherein the contactor module further includes an electrical fuse downstream from the positive and negative contactors and configured to selectively interrupt electrical flow across the positive and negative bus lines at a predefined maximum voltage and/or current.

8. The on-board DCFC system of claim 1, wherein the HV distribution unit electrically connects in between the vehicle FCS and the DC-to-DC converter, the DC-to-DC converter is electrically connected in between the HV distribution unit and the contactor module, and the contactor module is electrically connected in between the DC-to-DC converter and the electrical connector.

9. The on-board DCFC system of claim 1, wherein the DC-to-DC converter and the contactor module are configured to electrically connect to an auxiliary power module (APM) of the vehicle and receive therefrom an APM voltage to power operation of the DC-to-DC converter and the contactor module.

10. The on-board DCFC system of claim 1, further comprising a vehicle controller area network (CAN) module connected to the DC-to-DC converter and the contactor module, the vehicle CAN module configured to communicate with an on-board battery charge module (OBCM) of the transferee vehicle to receive therefrom data indicative of the recharge voltage.

11. The on-board DCFC system of claim 10, wherein the electrical connector includes a power cable coupled to the contactor module and a power plug, the power plug including an HVDC line pin and a control pilot pin, and wherein the vehicle CAN module is connected to the power plug and communicates with the OBCM via the control pilot pin.

12. The on-board DCFC system of claim 1, further comprising a DCFC module housing storing the DC-to-DC converter, the contactor module, and the electrical connector, the DCFC module housing being configured to detachably mount to a vehicle body of the vehicle.

13. The on-board DCFC system of claim 1, wherein the HV distribution unit includes an HV module housing containing the HV bus circuit, a first set of switches selectively electrically connecting positive and negative bus lines of the HV bus circuit to the vehicle FCS, and a second set of switches selectively electrically connecting the positive and negative bus lines of the HV bus circuit to the DC-to-DC converter.

14. An electric-drive vehicle, comprising:
a vehicle body;
a plurality of road wheels attached to the vehicle body;
an electrified powertrain attached to the vehicle body and operable to drive one or more of the road wheels to thereby propel the electric-drive vehicle;
a vehicle fuel cell system (FCS) attached to the vehicle body and configured to oxidize a hydrogen-based fuel and thereby generate an FCS voltage to power the electrified powertrain;
an electrical connector configured to electrically couple to a transferee vehicle;
a high-voltage (HV) distribution unit including an HV bus circuit electrically connected to the vehicle FCS and the electrified powertrain;
a DC-to-DC converter electrically connected to the HV bus circuit and configured to receive the FCS voltage from the HV distribution unit and modulate the FCS voltage to a recharge voltage requested by the transferee vehicle; and
a contactor module electrically connected to the DC-to-DC converter and the electrical connector and configured to selectively connect the DC-to-DC converter to the electrical connector to thereby transfer the recharge voltage to the transferee vehicle.

15. A method of assembling an on-board direct-current fast charger (DCFC) system to a vehicle, the vehicle including an electrified powertrain and a vehicle fuel cell system (FCS) configured to output an FCS voltage to power the electrified powertrain, the method comprising:
mounting an electrical connector and an HV distribution unit to the vehicle, the electrical connector configured to electrically couple the vehicle to a transferee vehicle;
electrically connecting a high-voltage (HV) bus circuit of the HV distribution unit to the vehicle FCS and the electrified powertrain;
electrically connecting a DC-to-DC converter to the HV bus circuit, the DC-to-DC converter configured to receive the FCS voltage from the HV distribution unit and modulate the FCS voltage to a recharge voltage of the transferee vehicle; and
electrically connecting a contactor module to the DC-to-DC converter and the electrical connector, the contactor module configured to selectively connect the DC-to-DC converter to the electrical connector to thereby transfer the recharge voltage to the transferee vehicle.

16. The method of claim 15, wherein the DC-to-DC converter includes a boost inductor electrically connected to the HV bus circuit, a high-voltage direct current (HVDC) bulk capacitor electrically connected to the contactor module, and a boost power module electrically connected to and interposed between the boost inductor and the HVDC capacitor.

17. The method of claim 16, wherein the boost inductor includes a plurality of inductor resistors electrically mutually parallel with each other and electrically connected to the HVDC bulk capacitor, and wherein the boost power module includes multiple gate terminal switches and multiple diodes each electrically connected in series to a respective one of the inductor resistors and a respective one of the gate terminal switches.

18. The method of claim 15, wherein the contactor module includes a contactor box with electrically-controlled positive and negative contactors electrically connected to positive and negative bus lines, respectively, of the HV bus circuit.

19. The method of claim 18, wherein the contactor module further includes a voltage and isolation resistance sensing meter electrically connected to the contactor box and configured to monitor a system resistance and/or a voltage output of the contactor module.

20. The method of claim 15, further comprising connecting a vehicle controller area network (CAN) module to the DC-to-DC converter and the contactor module, the vehicle CAN module configured to communicate with an on-board battery charge module (OBCM) of the transferee vehicle to receive therefrom data indicative of the recharge voltage.
